(19) United States
(12) Patent Application Publication
(10) Pub. No.: US 2026/0290082 A1
(43) Pub. Date: Sep. 24, 2026

(54) SYSTEM, INFORMATION PROCESSING APPARATUS, AND METHOD

(71) Applicant: TOYOTA JIDOSHA KABUSHIKI KAISHA, Toyota-shi Aichi-ken (JP)

(72) Inventor: Keizoh KAWAGUCHI, Okazaki-shi Aichi-ken (JP)

(73) Assignee: TOYOTA JIDOSHA KABUSHIKI KAISHA, Toyota-shi Aichi-ken (JP)

(21) Appl. No.: 19/568,084

(22) Filed: Mar. 16, 2026

(30) Foreign Application Priority Data
Mar. 19, 2025 (JP) 2025-045956

(51) Int. Cl. G07C 5/00; G06F 3/14; G07C 5/04

(52) U.S. Cl. CPC G07C 5/008; G06F 3/14; G07C 5/04

(57) ABSTRACT

An information processing apparatus mounted in a vehicle accepts a first notification indicating that a user has started a vehicle status check to display the status of the vehicle on a terminal apparatus. After the acceptance of the first notification, the information processing apparatus collects information on the vehicle and transmits the collected information at predetermined intervals. Then, after acceptance of a second notification indicating that the terminal apparatus has finished the vehicle status check, or after a predetermined time has elapsed since the acceptance of the first notification, the information processing apparatus stops the collection and transmission of the information on the vehicle.

### CROSS-REFERENCE TO RELATED APPLICATION

This application claims priority to Japanese Patent Application No. 2025-045956 filed on Mar. 19, 2025, the entire contents of which are incorporated herein by reference.

### TECHNICAL FIELD

The present disclosure relates to a system, an information processing apparatus, and a method.

### BACKGROUND

Technology related to a remote check service or a remote operation service is known. The remote check service allows users to check the status of vehicles using terminal apparatuses even when users are away from vehicles. The remote operation service allows users to operate in-vehicle devices using terminal apparatuses. For example, Patent Literature (PTL) 1 discloses technology for restricting remote operation functions or remote check functions depending on the states of charge of batteries of vehicles.

### CITATION LIST

### Patent Literature

PTL 1: JP 4556776 B2

### SUMMARY

Service that allows users to remotely check the status of vehicles requires power from the vehicles. The conventional remote check service has not sufficiently considered reducing the necessary power. Therefore, there is room for improvement in technology for remotely checking the status of vehicles.

It would be helpful to improve technology for remotely checking the status of vehicles.

A system according to an embodiment of the present disclosure is a system including:
a terminal apparatus of a user; and
an information processing apparatus mounted in a vehicle,
wherein
the terminal apparatus includes a display configured to display a vehicle status check screen,
the terminal apparatus is configured to:
   start a vehicle status check to display the status of the vehicle;
   acquire information on the vehicle;
   display the status of the vehicle on the vehicle status check screen based on the information; and
   then finish the vehicle status check, and
the information processing apparatus includes:
   a communication interface configured to receive a first notification indicating that the terminal apparatus has started the vehicle status check to display the status of the vehicle, or a second notification indicating that the terminal apparatus has finished the vehicle status check;
   a sensor configured to collect the information on the vehicle; and
   a processor configured to:
      after the acceptance of the first notification, transmit the information collected by the sensor from the communication interface at predetermined intervals; and
      after the acceptance of the second notification, or after a predetermined time has elapsed since the acceptance of the first notification, stop the collection and transmission of the information on the vehicle.

An information processing apparatus according to an embodiment of the present disclosure is an information processing apparatus mounted in a vehicle, the information processing apparatus including a controller configured to:
accept a first notification indicating that a user has started a vehicle status check to display the status of the vehicle on a terminal apparatus;
after the acceptance of the first notification, collect information on the vehicle and transmit the collected information at predetermined intervals; and
after acceptance of a second notification indicating that the terminal apparatus has finished the vehicle status check, or after a predetermined time has elapsed since the acceptance of the first notification, stop the collection and transmission of the information on the vehicle.

A method according to an embodiment of the present disclosure is a method performed by an information processing apparatus mounted in a vehicle, the method including:
accepting a first notification indicating that a user has started a vehicle status check to display the status of the vehicle on a terminal apparatus;
after the acceptance of the first notification, collecting information on the vehicle and transmitting the collected information at predetermined intervals; and
after acceptance of a second notification indicating that the terminal apparatus has finished the vehicle status check, or after a predetermined time has elapsed since the acceptance of the first notification, stopping the collection and transmission of the information on the vehicle.

According to an embodiment of the present disclosure, technology for remotely checking the status of vehicles is improved.

### BRIEF DESCRIPTION OF THE DRAWINGS

In the accompanying drawings:

FIG. 1 is a diagram illustrating a schematic configuration of a system according to an embodiment of the present disclosure;

FIG. 2 is a block diagram illustrating a schematic configuration of an information processing apparatus according to an embodiment of the present disclosure;

FIG. 3 is a block diagram illustrating a schematic configuration of a center server according to an embodiment of the present disclosure;

FIG. 4 is a flowchart illustrating operations of the information processing apparatus according to an embodiment of the present disclosure; and

FIG. 5 is a diagram illustrating an example of a vehicle status check screen of a terminal apparatus according to an embodiment of the present disclosure.

### DETAILED DESCRIPTION

Hereinafter, an aspect for implementing the present disclosure will be described with reference to the drawings. In each figure, the same reference numerals indicate the same or equivalent components.

### Outline of Embodiment

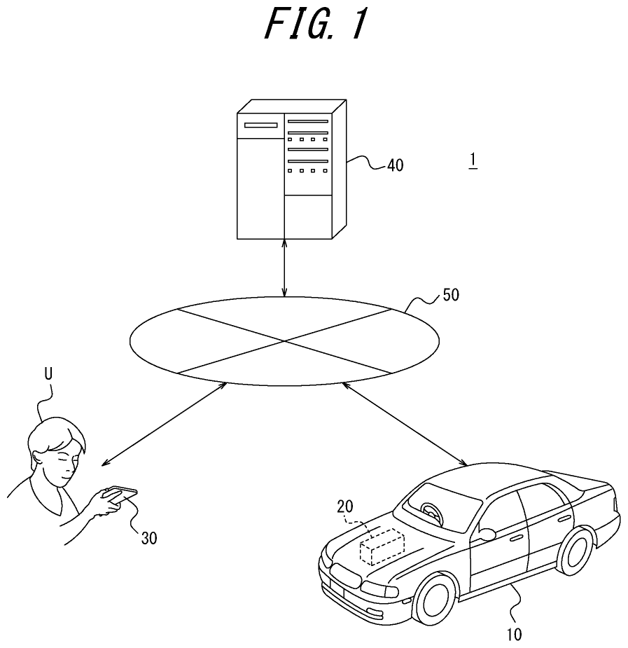

FIG. 1 illustrates a schematic configuration of a system 1 according to an embodiment of the present disclosure. The system 1 includes an information processing apparatus 20 mounted in a vehicle 10, a terminal apparatus 30 of a user U, and a center server 40. The information processing apparatus 20 of the vehicle 10, the terminal apparatus 30, and the center server 40 are communicably connected to each other via a network 50 including, for example, the Internet, a mobile communication network, and the like.

The vehicle 10 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

In the present embodiment, the vehicle 10 is equipped with the information processing apparatus 20 therein. The information processing apparatus 20 is, for example, a computer or a dedicated electronic device such as an Electronic Control Unit (ECU). The information processing apparatus 20 can communicate with the terminal apparatus 30 and the center server 40 via the network 50.

The terminal apparatus 30 is any apparatus used by the user U. For example, a general purpose electronic device such as a smartphone, a personal computer (PC), or a tablet terminal, or a dedicated electronic device may be used as the terminal apparatus 30. The terminal apparatus 30 can communicate with the information processing apparatus 20 of the vehicle 10 and the center server 40 via the network 50. FIG. 1 illustrates one terminal apparatus 30 in the system 1, but this is not limiting. The system 1 may include two or more terminal apparatuses 30.

The center server 40 is, for example, a server apparatus installed in a data center or the like. For example, the center server 40 is a server that belongs to a cloud computing system or another type of computing system. The center server 40 can communicate with the information processing apparatus 20 of the vehicle 10 and the terminal apparatus 30 via the network 50. FIG. 1 illustrates one center server 40 in the system 1, but this is not limiting. The system 1 may include two or more center servers 40.

The network 50 includes the Internet, at least one wide area network (WAN), at least one metropolitan area network (MAN), or a combination thereof. The network 50 may include at least one wireless network, at least one optical network, or a combination thereof. The wireless network is, for example, an ad hoc network, a cellular network, a wireless local area network (LAN), a satellite communication network, or a terrestrial microwave network.

A conventional remote vehicle status check (sometimes referred to simply as “remote check”) service will be described. In order to realize the remote check service, the information processing apparatus 20 of the vehicle 10 has conventionally been acquiring vehicle information constantly and notifying (uploading) the vehicle information to the center server 40 continuously (for example, every second). This has incurred high communication cost to transmit the latest vehicle information, thus leading to high operational cost. Additionally, when the vehicle 10 is in a stopped state (ignition power OFF; IGOFF), there has been a concern that a battery would be exhausted because the information is collected and communicated using battery power.

First, an outline of an embodiment of the present disclosure will be described, and details will be described later. The information processing apparatus 20 (or a controller thereof) mounted in the vehicle 10 accepts a first notification. The first notification is a notification indicating that the user U has started a vehicle status check to display the status of the vehicle 10 on the terminal apparatus 30. After the acceptance of the first notification, the information processing apparatus 20 collects information on the vehicle 10 and transmits the collected information at predetermined intervals. Then, after acceptance of a second notification indicating that the terminal apparatus 30 has finished the vehicle status check, or after a predetermined time has elapsed since the acceptance of the first notification, the information processing apparatus 20 stops the collection and transmission of the information on the vehicle 10.

According to the present embodiment, the information processing apparatus 20 mounted in the vehicle 10 starts the collection and transmission of the information on the vehicle 10 after the user U has started the vehicle status check of the vehicle 10 on the terminal apparatus 30. After the predetermined time has elapsed since that time, or when the terminal apparatus 30 has finished the vehicle status check, the information processing apparatus 20 finishes the collection and transmission of the information on the vehicle 10. Therefore, the information processing apparatus 20 collects and transmits the information on the vehicle 10 at the predetermined intervals only during the period (or a shorter period) when the user U is performing the vehicle status check of the vehicle 10 on the terminal apparatus 30. The information processing apparatus 20 does not constantly and continuously acquire and transmit vehicle information, in contrast to the conventional technology. As a result, according to the present disclosure, technology for remotely checking the status of vehicles is improved in terms of significant reductions in power and communication cost required for collecting and transmitting the information on the vehicle 10, compared to the conventional technology.

Next, configurations of the system 1 will be described in detail.

### (Configuration of Information Processing Apparatus of Vehicle)

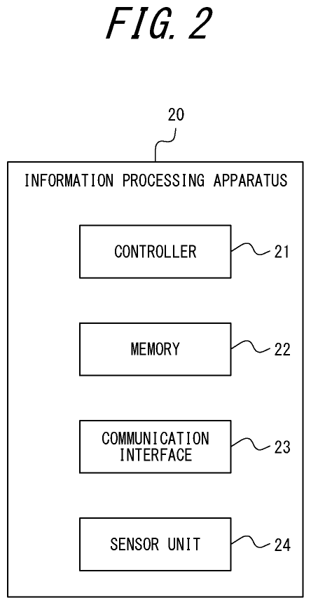

As illustrated in FIG. 2, the information processing apparatus 20 of the vehicle 10 includes a controller 21, a memory 22, a communication interface 23, and a sensor unit 24.

The controller 21 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is, for example, an application specific integrated circuit (ASIC), but is not limited to this. The controller 21 controls operations of the entire information processing apparatus 20.

In one embodiment, the controller 21 of the information processing apparatus 20 controls to start or finish the collection and transmission of information on the vehicle 10, based on a notification regarding a vehicle status check by the user U.

The memory 22 includes one or more memories. The memories are, for example, semiconductor memories, magnetic memories, optical memories, or the like, but are not limited to these. The semiconductor memories are, for example, random access memory (RAM) or read only memory (ROM). The RAM is, for example, static random access memory (SRAM) or dynamic random access memory (DRAM). The ROM is, for example, electrically erasable programmable read only memory (EEPROM). The memories included in the memory 22 may each function as, for example, a main memory, an auxiliary memory, or a cache memory. The memory 22 stores any information to be used for operations of the information processing apparatus 20. For example, the memory 22 may store a system program, an application program, embedded software, and the like. The information stored in the memory 22 may be updated with information acquired from the network 50 via the communication interface 23, for example.

The communication interface 23 includes at least one interface for communication to connect to the network 50. The communication interface 23 may include a plurality of the interfaces for communication. The interface for communication may be either a wired or wireless communication interface. For wired communication, the interface for communication is, for example, a local area network (LAN) interface or universal serial bus (USB). For wireless communication, the interface for communication is, for example, an interface compliant with a mobile communication standard such as Long Term Evolution (LTE), the 4th generation (4G), or the 5th generation (5G), or an interface compliant with a short-range wireless communication standard such as WiFi® (WiFi is a registered trademark in Japan, other countries, or both) or Bluetooth® (Bluetooth is a registered trademark in Japan, other countries, or both), but is not limited to these and may comply with any communication standard. The communication interface 23 receives data from an external or in-vehicle apparatus or the like, and transmits data obtained by operations of the information processing apparatus 20. The information processing apparatus 20 communicates with the terminal apparatus 30 and the center server 40 via the communication interface 23 and the network 50. In one embodiment, the communication interface 23 of the information processing apparatus 20 receives a first notification indicating that the terminal apparatus 30 of the user U has started a vehicle status check to display the status of the vehicle 10. The communication interface 23 also receives a second notification indicating that the terminal apparatus 30 has finished the vehicle status check.

The sensor unit 24 includes one or more sensors that acquire information on the vehicle 10. Specifically, the sensor unit 24 includes various sensors that acquire the open/closed state or lock state of the doors or windows of the vehicle 10 and the blinking state of the hazard lamps of the vehicle 10, a temperature sensor that measures the interior temperature of the vehicle 10, and the like. The sensor unit 24 may further include various sensors that measure the interior humidity, CO2 concentration, atmospheric pressure, the operation state (air volume, air direction) of the air conditioner, the remaining battery level of the vehicle 10, and the like. The sensor unit 24 may also include a global positioning system (GPS) for determining the position of the vehicle 10, and sensors that acquire drive information including the speed of the vehicle 10. The information processing apparatus 20 may include the sensor unit 24 as part of the apparatus 20, or may acquire information on the vehicle 10 from sensors external to the information processing apparatus 20 via the communication interface 23 or the like.

### (Configuration of Terminal Apparatus)

As with the information processing apparatus 20, the terminal apparatus 30 includes a controller, a memory, and a communication interface, and further includes an input interface (e.g. touch screen), a display (e.g. display), and sensors (e.g. GPS). A description of the specific details of each component of the terminal apparatus 30 is omitted.

### (Configuration of Center Server)

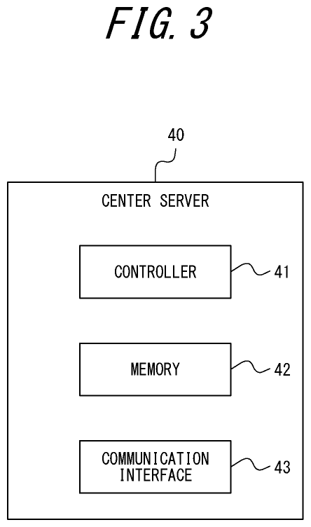

As illustrated in FIG. 3, the center server 40 includes a controller 41, a memory 42, and a communication interface 43.

The controller 41 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 41 controls operations of the entire center server 40.

The memory 42 includes one or more memories. The memories are, for example, semiconductor memories, magnetic memories, optical memories, or the like, but are not limited to these. The memories included in the memory 42 may each function as, for example, a main memory, an auxiliary memory, or a cache memory. The memory 42 stores any information to be used for operations of the center server 40. For example, the memory 42 may store a system program, an application program, a database, map information, and the like. The information stored in the memory 42 may be updated with, for example, information acquired from the network 50 via the communication interface 43.

In one embodiment, the memory 42 of the center server 40 stores information on the vehicle 10 transmitted from the vehicle 10. The memory 42 updates the information on the vehicle 10 based on information transmitted from the vehicle 10 at predetermined intervals, and stores the latest status information on the vehicle 10. Then, based on a service request for a vehicle status check from the terminal apparatus 30 of the user U, the center server 40 transmits the latest status information on the vehicle 10 to the terminal apparatus 30.

The communication interface 43 includes at least one interface for communication to connect to the network 50. The interface for communication may be either a wired or wireless communication interface, but wireless communication is desirable. For wireless communication, the interface for communication is, for example, an interface compliant with a mobile communication standard such as LTE, 4G, or 5G, or an interface compliant with a short-range wireless communication standard such as WiFi® or Bluetooth®, but is not limited to these and may comply with any communication standard. The center server 40 communicates with the information processing apparatus 20 of the vehicle 10 and the terminal apparatus 30 via the communication interface 43 and the network 50. In one embodiment, the communication interface 43 of the center server 40 receives information on the vehicle 10 from the information processing apparatus 20, and transmits the information on the vehicle 10 to the terminal apparatus 30.

### (Flow of Operations of Information Processing Apparatus)

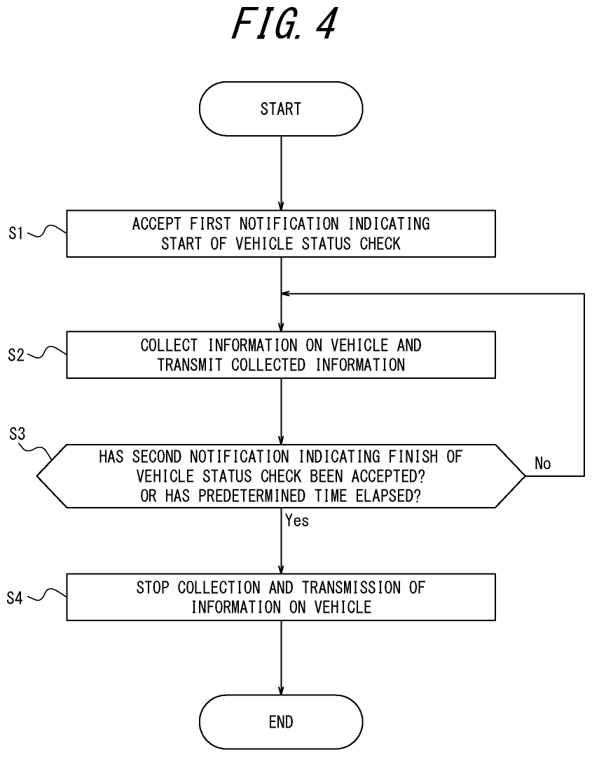

Operations of the information processing apparatus 20 (controller 21) according to a first embodiment will be described with reference to the flowchart of FIG. 4. The first embodiment corresponds to a case in which, in the system 1 of FIG. 1, the information processing apparatus 20 of the vehicle 10 and the terminal apparatus 30 of the user U communicate via the center server 40 to transmit and receive information. A case in which the information processing apparatus 20 and the terminal apparatus 30 transmit and receive information without going through the center server 40 will be described later as a second embodiment.

In S1 in FIG. 4 (hereinafter, each step of the flowchart will be identified as S and a number), the controller 21 of the information processing apparatus 20 accepts a first notification indicating that the user U has started a vehicle status check to display the status of the vehicle 10 on the terminal apparatus 30.

Specifically, first, the user U operates the terminal apparatus 30 to launch an application (hereinafter referred to as “remote control app”) for controlling the vehicle 10 while being away from the vehicle 10. Here, the remote control app provides multiple services. The user U selects, from the multiple services, a service (“remote check” service) to check the status of the vehicle 10. Based on the operation of the user U, the terminal apparatus 30 displays a vehicle status check screen on a display thereof. When the user U selects the service to check the status of the vehicle 10 (activates the vehicle status check screen), the terminal apparatus 30 transmits, to the center server 40, a signal to inquire about the current (or latest) status of the vehicle 10.

Upon receiving the signal inquiring about the status of the vehicle 10 from the terminal apparatus 30, the center server 40 transmits a first notification to the information processing apparatus 20 of the vehicle 10. The first notification indicates that the user U has started a vehicle status check to display the status of the vehicle 10 on the terminal apparatus 30. In S1, the communication interface 23 of the information processing apparatus 20 receives this first notification.

In S2, after the acceptance of the first notification, the controller 21 of the information processing apparatus 20 collects information on the vehicle 10 and transmits the collected information. This collection and transmission of the information is repeated at predetermined intervals.

Specifically, upon accepting the first notification via the communication interface 23, the controller 21 starts the collection of the information on the vehicle 10. The information on the vehicle 10 is collected using the sensor unit 24. For example, the open/closed state or lock state of the doors or windows of the vehicle 10, the blinking state of the hazard lamps, and the like are acquired from the various sensors associated with the doors and lamps. The temperature sensor measures the interior temperature of the vehicle 10. The global positioning system (GPS) of the vehicle 10 measures the position of the vehicle 10. In a case in which the vehicle 10 is in an activated state (ignition power ON; IGON), the sensor unit 24 may acquire drive information (various information indicating the driving state of the vehicle 10) including the speed of the vehicle 10.

Furthermore, the controller 21 transmits the collected information on the vehicle 10 to the center server 40 via the communication interface 23. In embodiments, the collection of the information on the vehicle 10 and the transmission of the collected information are performed at predetermined intervals. The predetermined interval can be set freely. For example, the controller 21 may collect and transmit the information every second. In embodiments, in a case in which the vehicle 10 is in the activated state (IGON), the information is collected and transmitted at short intervals because the status (drive information) of the vehicle 10 changes constantly.

Upon receiving the information on the vehicle 10 from the information processing apparatus 20 of the vehicle 10, the center server 40 stores the latest information on the vehicle 10 in the memory 42. The center server 40 transmits the information on the vehicle 10 to the terminal apparatus 30 of the user U via the communication interface 43. In embodiments, all of the information on the vehicle 10 transmitted from the information processing apparatus 20 at the predetermined intervals is transmitted to the terminal apparatus 30 in order. The terminal apparatus 30 displays the current status of the vehicle 10 on the vehicle status check screen of the display, based on the received information on the vehicle 10.

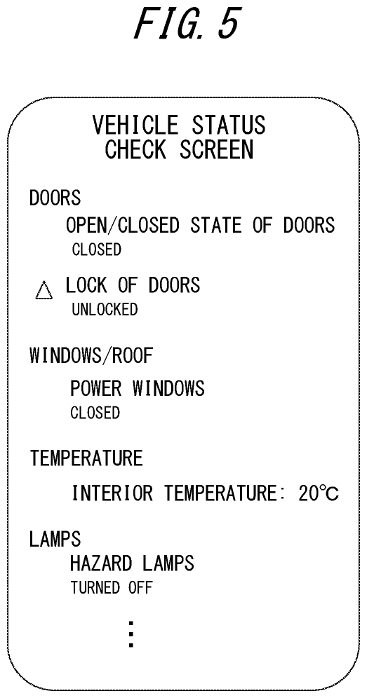

FIG. 5 is an example of the vehicle status check screen displayed on the display of the terminal apparatus 30 of the user U. The vehicle status check screen displays the current (or latest) status of the vehicle 10. In FIG. 5, items of doors, windows/roof, temperature, and lamps are illustrated. For the doors, it is displayed that the doors are currently closed and that the door lock is unlocked. For the door lock, a caution symbol (triangle symbol) is also displayed. For the windows/roof, it is displayed that the power windows are closed. For the temperature, it is displayed that the interior temperature is 20° C. For the lamps, it is displayed that the hazard lamps are turned off. These items are an example, and the vehicle status check screen may further display various types of status of the vehicle 10. For example, the vehicle status check screen may display the position of the vehicle 10. Additionally, the vehicle status check screen may display the drive information including the speed of the vehicle 10.

In embodiments, upon receiving the information on the vehicle 10, the terminal apparatus 30 automatically updates the vehicle status check screen based on the received information. The automatic update enables the vehicle status check screen to always display the latest status of the vehicle 10. This allows the user U to check the information on the vehicle 10 in real-time. Note that, this display method is an example, and instead of the automatic update of the vehicle status check screen, a status update button may be provided on the vehicle status check screen. That is, each time the user U presses (clicks) the status update button, the terminal apparatus 30 acquires the latest information on the vehicle 10 stored in the center server 40, and displays the latest information on the vehicle status check screen. In this case, the user U can check the latest information on the vehicle 10 at any time chosen by the user.

In S3 in FIG. 4, the controller 21 of the information processing apparatus 20 determines whether to have accepted a second notification indicating that the terminal apparatus 30 has finished the vehicle status check, or whether a predetermined time has elapsed since the acceptance of the first notification. When it is determined that the second notification has been accepted, or that the predetermined time has elapsed since the acceptance of the first notification (S3—Yes), the process proceeds to S4. On the other hand, when it is determined that the second notification has not been accepted and that the predetermined time has not elapsed since the acceptance of the first notification (S3—No), the process returns to S2.

Specifically, the user U operates the terminal apparatus 30 to finish checking the status of the vehicle 10. Based on the finish operation by the user U, the terminal apparatus 30 transmits, to the center server 40, a signal indicating the finish of the vehicle status check of the vehicle 10. Note that, the user U finishing checking of the status of the vehicle 10 is not limited to closing the vehicle status check screen and finishing the vehicle status check service. For example, the user U displaying another application screen on the terminal apparatus 30 (the vehicle status check screen being no longer an active display screen) may be included in finishing the vehicle status check.

Upon receiving, from the terminal apparatus 30, the signal indicating the finish of the vehicle status check of the vehicle 10, the center server 40 transmits a second notification to the information processing apparatus 20 of the vehicle 10. The second notification is a notification indicating that the terminal apparatus 30 has finished the vehicle status check. In S3, the controller 21 of the information processing apparatus 20 determines whether the communication interface 23 has received this second notification.

Alternatively, in S3, the controller 21 of the information processing apparatus 20 determines whether a predetermined time has elapsed since the acceptance of the first notification, which indicates the start of the vehicle status check. Here, the predetermined time can be set freely, for example, to 2 minutes. This predetermined time can be set appropriately within a range in which power consumption (electrical energy required for collecting and transmitting the information on the vehicle 10) by the vehicle status check service does not adversely affect the state of charge of the battery of the vehicle 10.

As described above, when it is determined that the controller 21 of the information processing apparatus 20 has not accepted the second notification and the predetermined time has not elapsed since the acceptance of the first notification (S3—No), the process returns to S2. The controller 21 then re-performs processing of collecting information on the vehicle 10 and transmitting the collected information. For example, the aforementioned predetermined interval may correspond to the period from the time when the controller 21 has performed the processing of collecting and transmitting the information on the vehicle 10 until the time when the controller 21 determines whether the second notification has been accepted or whether the predetermined time has elapsed. By setting such a period, S2 and S3 can be repeated at the predetermined intervals, and the collection and transmission of the information on the vehicle 10 are performed at the predetermined intervals until the determination of S3 becomes Yes.

Then, in S4, after the acceptance of the second notification or after the predetermined time has elapsed since the acceptance of the first notification, the controller 21 of the information processing apparatus 20 stops the collection and transmission of the information on the vehicle 10. The process then ends.

When the transmission of the information on the vehicle 10 from the information processing apparatus 20 is stopped, the center server 40 stores the last received information on the vehicle 10 in the memory 42. When the information processing apparatus 20 stops the transmission of the information on the vehicle 10 due to the acceptance of the second notification, the center server 40 stops the transmission of the information on the vehicle 10 to the terminal apparatus 30. In embodiments, when the information processing apparatus 20 stops the transmission of the information on the vehicle 10 due to the predetermined time having elapsed since the acceptance of the first notification, the center server 40 notifies the terminal apparatus 30 that the transmission of the information on the vehicle 10 from the information processing apparatus 20 has stopped. After this, the center server 40 may stop the transmission of the information on the vehicle 10 to the terminal apparatus 30, or may transmit the last received information on the vehicle 10 to the terminal apparatus 30 at predetermined intervals.

As described above, according to the present embodiment, the information processing apparatus 20 starts the collection and transmission of the information on the vehicle 10 after the user U has started the vehicle status check of the vehicle 10 on the terminal apparatus 30, and after the predetermined time has elapsed since that time or when the terminal apparatus 30 has finished the vehicle status check, the information processing apparatus 20 finishes the collection and transmission of the information on the vehicle 10. Therefore, the information processing apparatus 20 collects and transmits the information on the vehicle 10 at the predetermined intervals only during the period when the user U is performing the vehicle status check of the vehicle 10 on the terminal apparatus 30. As a result, the power and communication cost required for collecting and transmitting the information on the vehicle 10 are significantly reduced, compared to conventional technology.

Supplementary explanation will be provided regarding the operations of the information processing apparatus 20 (or controller 21) illustrated in FIG. 4. In the determination of S3, the conditions for stopping the collection and transmission of the information on the vehicle 10 may be set in more detail.

In S3 and S4, in a case in which the vehicle 10 is in the activated state (IGON), the controller 21 of the information processing apparatus 20 stops the collection and transmission of the information on the vehicle 10 after the acceptance of the second notification. That is, in a case in which the vehicle 10 is in the activated state (IGON), the collection and transmission of the information on the vehicle 10 are not stopped even when the predetermined time has elapsed since the acceptance of the first notification, and the collection and transmission of the information on the vehicle 10 are stopped when the second notification has been accepted. With this setting, the information on the vehicle 10 is always transmitted during the period when the user U is performing the vehicle status check of the vehicle 10 on the terminal apparatus 30, and the latest information is displayed on the vehicle status check screen. In a case in which the vehicle 10 is in the activated state (IGON), there is enough power in the vehicle 10, so the vehicle status check service for the user U can be provided with priority.

In S3 and S4, in a case in which the vehicle 10 is in the stopped state (IGOFF), the controller 21 of the information processing apparatus 20 stops the collection and transmission of the information on the vehicle 10 at the earlier of after the acceptance of the second notification or after the predetermined time has elapsed since the acceptance of the first notification. That is, in a case in which the vehicle 10 is in the stopped state (IGOFF), priority is given to whichever occurs earlier: when the predetermined time (for example, 2 minutes) has elapsed since the acceptance of the first notification; or when the second notification has been accepted, and the collection and transmission of the information on the vehicle 10 is stopped. Therefore, the period for collecting and transmitting the information on the vehicle 10 is shortened, and power consumption is reduced. In a case in which the vehicle 10 is in the stopped state (IGOFF), the collection and transmission of the information on the vehicle 10 is performed using the power of the battery mounted in the vehicle 10. This setting reduces the risk of battery exhaustion while the vehicle 10 is stopped.

Furthermore, in S3 and S4, in a case in which the vehicle 10 is in the stopped state (IGOFF), the controller 21 of the information processing apparatus 20 stops the collection and transmission of the information on the vehicle 10 at the earliest of the time after the acceptance of the second notification, the time after the predetermined time has elapsed since the acceptance of the first notification, and the time when the remaining battery level is lower than a predetermined value. That is, in a case in which the vehicle 10 is in the stopped state (IGOFF), the condition of the time when the remaining battery level is low is added to the conditions of the time after the predetermined time has elapsed since the acceptance of the first notification and the time after the acceptance of the second notification, and priority is given to the earliest of these conditions to stop the collection and transmission of the information on the vehicle 10. Therefore, when the remaining battery level is low, the period for collecting and transmitting the information on the vehicle 10 is further shortened, so power consumption is reduced. In a case in which the vehicle 10 is in the stopped state (IGOFF), the collection and transmission of the information on the vehicle 10 are performed considering the remaining power of the battery mounted in the vehicle 10. This setting further reduces the risk of battery exhaustion while the vehicle 10 is stopped.

Next, a variation of the aforementioned embodiment will be described. In the above embodiment, the controller 21 of the information processing apparatus 20 repeatedly collects and transmits the information on the vehicle at the predetermined intervals after the acceptance of the first notification. On the other hand, in the variation, in a case in which the vehicle 10 is in the stopped state (IGOFF), the controller 21 of the information processing apparatus 20 transmits the information on the vehicle 10 only when there is some change or update in the status of the vehicle 10, instead of transmitting the information on the vehicle 10 at the predetermined intervals. This is based on the fact that the information on the vehicle 10 changes less frequently when the vehicle 10 is in the stopped state (IGOFF). Even if the information on the vehicle 10 is not transmitted when the information has not changed, the latest information on the vehicle 10, which is the same as the current one, is stored in the memory 42 of the center server 40, so there is no hindrance to the display of the information on the vehicle 10 on the terminal apparatus 30. Not transmitting the information on the vehicle 10 when there is no change in the information on the vehicle 10 contributes to savings in power and communication cost associated with the transmission of the information. In a case in which the vehicle 10 is in the stopped state (IGOFF), the collection and transmission of the information on the vehicle 10 is performed using the power of the battery mounted in the vehicle 10. This variation can further reduce the risk of battery exhaustion while the vehicle 10 is stopped. Note that, any method can be employed for the determination process of whether there is any change or update in the status of the vehicle 10. For example, the controller 21 may periodically collect the information on the vehicle 10, calculate the rate of change of state quantities, and determine whether such change rate is within a predetermined range. The state quantities include the interior temperature, humidity, CO2 concentration, and atmospheric pressure, the operation state (air volume, air direction) of the air conditioner, the remaining battery level, energy consumption status, and open/closed state of the doors and windows of the vehicle 10, and the like. The open/closed state of the doors and windows can be expressed in binary, for example, with 1 for open and 0 for closed. Alternatively, the open/closed state can be set to a continuous value according to the degree of opening (for example, 0 to 100%).

Next, another variation of the aforementioned embodiment will be described. In the above embodiment, the first notification is notified when the terminal apparatus 30 has opened the vehicle status check screen to display the status of the vehicle after the launch of the application for the vehicle status check. On the other hand, in this variation, the first notification is notified when the terminal apparatus 30 has launched the application for the vehicle status check. Specifically, the user U operates the terminal apparatus 30 to launch the application for controlling the vehicle 10 while being away from the vehicle 10. In this variation, at the stage of launching the application (before opening the vehicle status check screen), the terminal apparatus 30 transmits, to the center server 40, a signal indicating the start of the application.

Upon receiving, from the terminal apparatus 30, the signal indicating that the start of the application, the center server 40 transmits a first notification to the information processing apparatus 20 of the vehicle 10 before the user U displays the vehicle status check screen on the display. Then, in S1, the communication interface 23 of the information processing apparatus 20 receives this first notification. The controller 21 of the information processing apparatus 20 immediately collects information on the vehicle 10 and transmits the collected information. This allows the center server 40 to receive the information on the vehicle 10, before the terminal apparatus 30 displays the vehicle status check screen on the display. Therefore, when the terminal apparatus 30 transmits, to the center server 40, a signal to inquire about the current (or latest) status of the vehicle 10 along with the display of the vehicle status check screen, the information on the vehicle 10 is already stored in the center server 40. Thus, the center server 40 can immediately transmit the information on the vehicle 10 to the terminal apparatus 30. According to this variation, when the user U displays the vehicle status check screen on the terminal apparatus 30, the current vehicle status is displayed without any waiting time. Therefore, the remote check service for the user U is improved.

### Second Embodiment

Next, operations of the information processing apparatus 20 (controller 21) according to a second embodiment will be described. The second embodiment corresponds to a case in which the information processing apparatus 20 of the vehicle 10 and the terminal apparatus 30 of the user U communicate directly with each other to transmit and receive information. Therefore, the center server 40 is not used for a remote check service. Any wireless communication method can be used as the communication means between the information processing apparatus 20 and the terminal apparatus 30. Hereinafter, a description of common contents with the first embodiment will be omitted or simplified.

In S1 in FIG. 4, the user U operates the terminal apparatus 30 to launch an application for controlling the vehicle 10 while being away from the vehicle 10. The user U further selects a service to check the status of the vehicle 10. Based on the operation of the user U, the terminal apparatus 30 displays a vehicle status check screen on a display thereof. Along with the operation of the user U selecting the service to check the status of the vehicle 10 (activating the vehicle status check screen), the terminal apparatus 30 transmits, to the information processing apparatus 20 of the vehicle 10, a signal to inquire about the current (or latest) vehicle status. In the second embodiment, this signal inquiring about the vehicle status corresponds to a first notification indicating that the user has started a vehicle status check to display the status of the vehicle 10 on the terminal apparatus 30. In S1 in FIG. 4, the communication interface 23 of the information processing apparatus 20 receives this first notification, and the controller 21 accepts the first notification.

Here, although it is explained that the signal inquiring about the vehicle status corresponds to the first notification, as in another variation mentioned earlier, the first notification may be a signal indicating that the terminal apparatus 30 has started the application for the vehicle status check.

In S2, after the acceptance of the first notification, the controller 21 of the information processing apparatus 20 collects information on the vehicle 10. The information on the vehicle 10 is collected using the sensor unit 24. The controller 21 then transmits the collected information on the vehicle 10 to the terminal apparatus 30 via the communication interface 23. In embodiments, the collection of the information on the vehicle 10 and the transmission of the collected information are performed at predetermined intervals. As a result, the current status of the vehicle 10 is displayed on the vehicle status check screen on the display of the terminal apparatus 30. In embodiments, upon receiving new information on the vehicle 10, the terminal apparatus 30 automatically updates the vehicle status check screen.

In S3 in FIG. 4, the controller 21 of the information processing apparatus 20 determines whether to have accepted a second notification indicating that the terminal apparatus 30 has finished the vehicle status check, or whether a predetermined time has elapsed since the acceptance of the first notification. In the present embodiment, the user U operates the terminal apparatus 30 to finish checking the status of the vehicle 10. Based on the finish operation by the user U, the terminal apparatus 30 transmits, to the information processing apparatus 20, a signal indicating the finish of the vehicle status check of the vehicle 10. In the present embodiment, the signal transmitted from the terminal apparatus 30 to indicate the finish of the vehicle status check corresponds to the second notification.

In S3, the controller 21 of the information processing apparatus 20 determines whether the communication interface 23 has received this second notification. Alternatively, the controller 21 determines whether a predetermined time (for example, 2 minutes) has elapsed since the acceptance of the first notification, which indicates the start of the vehicle status check.

As described above, when it is determined that the controller 21 of the information processing apparatus 20 has not accepted the second notification and the predetermined time has not elapsed since the acceptance of the first notification (S3—No), the process returns to S2. Then, until the determination in S3 becomes Yes, the information on the vehicle 10 is collected and transmitted at the predetermined intervals.

When the determination in S3 is Yes, the process proceeds to S4, and the controller 21 of the information processing apparatus 20 stops the collection and transmission of the information on the vehicle 10. The process then ends.

As described above, also in the present embodiment, the information processing apparatus 20 starts the collection and transmission of the information on the vehicle 10 after the user U has started the vehicle status check of the vehicle 10 on the terminal apparatus 30, and after the predetermined time has elapsed since that time or when the terminal apparatus 30 has finished the vehicle status check, the information processing apparatus 20 finishes the collection and transmission of the information on the vehicle 10. Therefore, the information processing apparatus 20 collects and transmits the information on the vehicle 10 at the predetermined intervals only during the period when the user U is performing the vehicle status check of the vehicle 10 on the terminal apparatus 30. As a result, the power and communication cost required for collecting and transmitting the information on the vehicle 10 are significantly reduced, compared to conventional technology.

Also in the second embodiment, as in the first embodiment, the conditions for stopping the collection and transmission of the information on the vehicle 10 may be set in more detail. That is, in a case in which the vehicle 10 is in an activated state (IGON), the controller 21 of the information processing apparatus 20 stops the collection and transmission of the information on the vehicle 10 after the acceptance of the second notification. In a case in which the vehicle 10 is in a stopped state (IGOFF), the controller 21 of the information processing apparatus 20 stops the collection and transmission of the information on the vehicle 10 at the earlier of after the acceptance of the second notification or after the predetermined time has elapsed since the acceptance of the first notification. Furthermore, in a case in which the vehicle 10 is in the stopped state (IGOFF), the controller 21 of the information processing apparatus 20 may stop the collection and transmission of the information on the vehicle 10 when the remaining battery level is lower than a predetermined value. This setting reduces the risk of battery exhaustion while the vehicle 10 is stopped.

Also in the second embodiment, as in the first embodiment, a variation of the transmission process can be adopted. That is, in a case in which the vehicle 10 is in the stopped state (IGOFF), the controller 21 of the information processing apparatus 20 transmits the information on the vehicle 10 only when there is some change or update in the status of the vehicle 10, instead of transmitting the information on the vehicle 10 at the predetermined intervals. The variation can further reduce the risk of battery exhaustion while the vehicle 10 is stopped.

As described above, as in the first embodiment, the information processing apparatus 20 according to the second embodiment starts the collection and transmission of the information on the vehicle 10 after the user U has started the vehicle status check of the vehicle 10 on the terminal apparatus 30, and after the predetermined time has elapsed since that time or when the terminal apparatus 30 has finished the vehicle status check, the information processing apparatus 20 finishes the collection and transmission of the information on the vehicle 10.

According to such a configuration, the information processing apparatus 20 collects and transmits the information on the vehicle 10 at the predetermined intervals only during the period when the user U is performing the vehicle status check of the vehicle 10 on the terminal apparatus 30. Therefore, according to the present embodiment, technology for remotely checking the status of vehicles is improved in terms of significant reductions in power and communication cost required for collecting and transmitting the information on the vehicle 10, compared to the conventional technology.

It is also possible to cause a computer capable of executing any program to function as the information processing apparatus 20 described above. The program may be program code, code segments, or the like for executing necessary tasks. The program causes a computer to execute operations of the information processing apparatus 20, thereby causing the computer to function as the information processing apparatus 20. That is, the computer executes the operations of the information processing apparatus 20 in accordance with the program to thereby function as the information processing apparatus 20.

In one embodiment, a computer temporarily stores a program recorded on a portable recording medium or a program transmitted from a server in the main memory. Then, the computer reads the program stored in the main memory using the processor, and executes processes in accordance with the read program using the processor. The computer may read a program directly from a portable recording medium, and execute processes in accordance with the program. Each time the computer receives a program from an external server, the computer may sequentially execute processes in accordance with the received program. Without transmitting a program from an external server to the computer, processing may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is “equivalent to a program” in this context.

In one embodiment, a program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

Examples of some embodiments of the present disclosure are described below. However, it should be noted that the embodiments of the present disclosure are not limited to these examples.

[Appendix 1] A system comprising:
a terminal apparatus of a user; and
an information processing apparatus mounted in a vehicle,
wherein
the terminal apparatus comprises a display configured to display a vehicle status check screen,
the terminal apparatus is configured to:
   start a vehicle status check to display a status of the vehicle;
   acquire information on the vehicle;
   display the status of the vehicle on the vehicle status check screen based on the information; and
   then finish the vehicle status check, and
the information processing apparatus comprises:
   a communication interface configured to receive a first notification indicating that the terminal apparatus has started the vehicle status check to display the status of the vehicle, or a second notification indicating that the terminal apparatus has finished the vehicle status check;
   a sensor configured to collect the information on the vehicle; and
   a processor configured to:
      after acceptance of the first notification, transmit the information collected by the sensor from the communication interface at predetermined intervals; and
      after acceptance of the second notification, or after a predetermined time has elapsed since the acceptance of the first notification, stop collection and transmission of the information on the vehicle.
         [Appendix 2] The system according to appendix 1, further comprising a center server configured to transmit the first notification or the second notification to the information processing apparatus, store the information on the vehicle transmitted from the information processing apparatus, and transmit the information to the terminal apparatus.
         [Appendix 3] An information processing apparatus mounted in a vehicle, the information processing apparatus comprising a controller configured to:
accept a first notification indicating that a user has started a vehicle status check to display a status of the vehicle on a terminal apparatus;
after acceptance of the first notification, collect information on the vehicle and transmit the collected information at predetermined intervals; and
after acceptance of a second notification indicating that the terminal apparatus has finished the vehicle status check, or after a predetermined time has elapsed since the acceptance of the first notification, stop collection and transmission of the information on the vehicle.
   [Appendix 4] The information processing apparatus according to appendix 3, wherein in a case in which the vehicle is in an activated state (IGON), the controller is configured to stop the collection and transmission of the information on the vehicle after the acceptance of the second notification.
   [Appendix 5] The information processing apparatus according to appendix 3 or 4, wherein in a case in which the vehicle is in a stopped state (IGOFF), the controller is configured to stop the collection and transmission of the information on the vehicle at an earlier of after the acceptance of the second notification or after a predetermined time has elapsed since the acceptance of the first notification.
   [Appendix 6] The information processing apparatus according to any one of appendices 3 to 5, wherein in a case in which the vehicle is in the stopped state (IGOFF), the controller is configured to stop the collection and transmission of the information on the vehicle at an earliest of a time after the acceptance of the second notification, a time after a predetermined time has elapsed since the acceptance of the first notification, and a time when a remaining battery level is lower than a predetermined value.
   [Appendix 7] The information processing apparatus according to any one of appendices 3 to 6, wherein in a case in which the vehicle is in a stopped state (IGOFF), the controller is configured to collect the information on the vehicle at predetermined intervals, and transmit the information on the vehicle only when there is some change or update in the status of the vehicle, instead of transmitting the information on the vehicle at predetermined intervals.
   [Appendix 8] The information processing apparatus according to any one of appendices 3 to 7, wherein the first notification is notified when the terminal apparatus has launched an application for the vehicle status check.
   [Appendix 9] The information processing apparatus according to any one of appendices 3 to 7, wherein the first notification is notified when the terminal apparatus has opened a vehicle status check screen to display the status of the vehicle after a launch of an application for the vehicle status check.
   [Appendix 10] The information processing apparatus according to any one of appendices 3 to 9, wherein the information on the vehicle includes any of an open/closed state or lock state of a door or window, a blinking state of hazard lamps, a position of the vehicle, an interior temperature of the vehicle, and drive information including a speed of the vehicle.
   [Appendix 11] The information processing apparatus according to any one of appendices 3 to 10, wherein the first notification and the second notification are transmitted from a center server, and the information processing apparatus is configured to transmit the information on the vehicle to the center server.
   [Appendix 12] A method performed by an information processing apparatus mounted in a vehicle, the method comprising:
accepting a first notification indicating that a user has started a vehicle status check to display a status of the vehicle on a terminal apparatus;
after acceptance of the first notification, collecting information on the vehicle and transmitting the collected information at predetermined intervals; and
after acceptance of a second notification indicating that the terminal apparatus has finished the vehicle status check, or after a predetermined time has elapsed since the acceptance of the first notification, stopping collection and transmission of the information on the vehicle.
   [Appendix 13] The method according to appendix 12, comprising, in a case in which the vehicle is in an activated state (IGON), stopping the collection and transmission of the information on the vehicle after the acceptance of the second notification.
   [Appendix 14] The method according to appendix 12 or 13, comprising, in a case in which the vehicle is in a stopped state (IGOFF), stopping the collection and transmission of the information on the vehicle at an earlier of after the acceptance of the second notification or after a predetermined time has elapsed since the acceptance of the first notification.
   [Appendix 15] The method according to any one of appendices 12 to 14, comprising, in a case in which the vehicle is in the stopped state (IGOFF), stopping the collection and transmission of the information on the vehicle at an earliest of a time after the acceptance of the second notification, a time after a predetermined time has elapsed since the acceptance of the first notification, and a time when a remaining battery level is lower than a predetermined value.
   [Appendix 16] The method according to any one of appendices 12 to 15, comprising, in a case in which the vehicle is in a stopped state (IGOFF), collecting the information on the vehicle at predetermined intervals, and transmitting the information on the vehicle only when there is some change or update in the status of the vehicle, instead of transmitting the information on the vehicle at predetermined intervals.
   [Appendix 17] The method according to any one of appendices 12 to 16, wherein the first notification is notified when the terminal apparatus has launched an application for the vehicle status check.
   [Appendix 18] The method according to any one of appendices 12 to 16, wherein the first notification is notified when the terminal apparatus has opened a vehicle status check screen to display the status of the vehicle after a launch of an application for the vehicle status check.
   [Appendix 19] The method according to any one of appendices 12 to 18, wherein the information on the vehicle includes any of an open/closed state or lock state of a door or window, a blinking state of hazard lamps, a position of the vehicle, an interior temperature of the vehicle, and drive information including a speed of the vehicle.
   [Appendix 20] The method according to any one of appendices 12 to 19, wherein
the first notification and the second notification are transmitted from a center server, and
the method comprises transmitting the information on the vehicle to the center server.

1. A system comprising:
a terminal apparatus of a user; and
an information processing apparatus mounted in a vehicle,
wherein
the terminal apparatus comprises a display configured to display a vehicle status check screen,
the terminal apparatus is configured to:
start a vehicle status check to display a status of the vehicle;
acquire information on the vehicle;
display the status of the vehicle on the vehicle status check screen based on the information; and
then finish the vehicle status check, and
the information processing apparatus comprises:
a communication interface configured to receive a first notification indicating that the terminal apparatus has started the vehicle status check to display the status of the vehicle, or a second notification indicating that the terminal apparatus has finished the vehicle status check;
a sensor configured to collect the information on the vehicle; and
a processor configured to:
after acceptance of the first notification, transmit the information collected by the sensor from the communication interface at predetermined intervals; and
after acceptance of the second notification, or after a predetermined time has elapsed since the acceptance of the first notification, stop collection and transmission of the information on the vehicle.

2. The system according to claim 1, further comprising a center server configured to transmit the first notification or the second notification to the information processing apparatus, store the information on the vehicle transmitted from the information processing apparatus, and transmit the information to the terminal apparatus.

3. An information processing apparatus mounted in a vehicle, the information processing apparatus comprising a controller configured to:
accept a first notification indicating that a user has started a vehicle status check to display a status of the vehicle on a terminal apparatus;
after acceptance of the first notification, collect information on the vehicle and transmit the collected information at predetermined intervals; and
after acceptance of a second notification indicating that the terminal apparatus has finished the vehicle status check, or after a predetermined time has elapsed since the acceptance of the first notification, stop collection and transmission of the information on the vehicle.

4. The information processing apparatus according to claim 3, wherein in a case in which the vehicle is in an activated state (IGON), the controller is configured to stop the collection and transmission of the information on the vehicle after the acceptance of the second notification.

5. The information processing apparatus according to claim 3, wherein in a case in which the vehicle is in a stopped state (IGOFF), the controller is configured to stop the collection and transmission of the information on the vehicle at an earlier of after the acceptance of the second notification or after a predetermined time has elapsed since the acceptance of the first notification.

6. The information processing apparatus according to claim 5, wherein in a case in which the vehicle is in the stopped state (IGOFF), the controller is configured to stop the collection and transmission of the information on the vehicle at an earliest of a time after the acceptance of the second notification, a time after a predetermined time has elapsed since the acceptance of the first notification, and a time when a remaining battery level is lower than a predetermined value.

7. The information processing apparatus according to claim 3, wherein in a case in which the vehicle is in a stopped state (IGOFF), the controller is configured to collect the information on the vehicle at predetermined intervals, and transmit the information on the vehicle only when there is some change or update in the status of the vehicle, instead of transmitting the information on the vehicle at predetermined intervals.

8. The information processing apparatus according to claim 3, wherein the first notification is notified when the terminal apparatus has launched an application for the vehicle status check.

9. The information processing apparatus according to claim 3, wherein the first notification is notified when the terminal apparatus has opened a vehicle status check screen to display the status of the vehicle after a launch of an application for the vehicle status check.

10. The information processing apparatus according to claim 3, wherein the information on the vehicle includes any of an open/closed state or lock state of a door or window, a blinking state of hazard lamps, a position of the vehicle, an interior temperature of the vehicle, and drive information including a speed of the vehicle.

11. The information processing apparatus according to claim 3, wherein
the first notification and the second notification are transmitted from a center server, and
the information processing apparatus is configured to transmit the information on the vehicle to the center server.

12. A method performed by an information processing apparatus mounted in a vehicle, the method comprising:
accepting a first notification indicating that a user has started a vehicle status check to display a status of the vehicle on a terminal apparatus;
after acceptance of the first notification, collecting information on the vehicle and transmitting the collected information at predetermined intervals; and
after acceptance of a second notification indicating that the terminal apparatus has finished the vehicle status check, or after a predetermined time has elapsed since the acceptance of the first notification, stopping collection and transmission of the information on the vehicle.

13. The method according to claim 12, comprising, in a case in which the vehicle is in an activated state (IGON), stopping the collection and transmission of the information on the vehicle after the acceptance of the second notification.

14. The method according to claim 12, comprising, in a case in which the vehicle is in a stopped state (IGOFF), stopping the collection and transmission of the information on the vehicle at an earlier of after the acceptance of the second notification or after a predetermined time has elapsed since the acceptance of the first notification.

15. The method according to claim 14, comprising, in a case in which the vehicle is in the stopped state (IGOFF), stopping the collection and transmission of the information on the vehicle at an earliest of a time after the acceptance of the second notification, a time after a predetermined time has elapsed since the acceptance of the first notification, and a time when a remaining battery level is lower than a predetermined value.

16. The method according to claim 12, comprising, in a case in which the vehicle is in a stopped state (IGOFF), collecting the information on the vehicle at predetermined intervals, and transmitting the information on the vehicle only when there is some change or update in the status of the vehicle, instead of transmitting the information on the vehicle at predetermined intervals.

17. The method according to claim 12, wherein the first notification is notified when the terminal apparatus has launched an application for the vehicle status check.

18. The method according to claim 12, wherein the first notification is notified when the terminal apparatus has opened a vehicle status check screen to display the status of the vehicle after a launch of an application for the vehicle status check.

19. The method according to claim 12, wherein the information on the vehicle includes any of an open/closed state or lock state of a door or window, a blinking state of hazard lamps, a position of the vehicle, an interior temperature of the vehicle, and drive information including a speed of the vehicle.

20. The method according to claim 12, wherein
the first notification and the second notification are transmitted from a center server, and
the method comprises transmitting the information on the vehicle to the center server.
